(19) United States
(12) Patent Application Publication
(10) Pub. No.: US 2011/0146431 A1
(43) Pub. Date: Jun. 23, 2011

(54) RIGID BEAM OF PORTAL FRAME TYPE PLATFORM

(76) Inventors: Tung-Hsin CHEN, Taichung City (TW); Huang Ming Lin, Taichung City (TW)

(21) Appl. No.: 12/686,500

(22) Filed: Jan. 13, 2010

(30) Foreign Application Priority Data
Dec. 22, 2009 (TW) 98223971

(51) Int. Cl. F16S 3/00

(52) U.S. Cl. 74/1 R

(57) ABSTRACT

A rigid beam of portal frame type platform, including a hollow body section with a substantially rectangular cross section. The body section linearly extends by a predetermined length. At least one diaphragm section is disposed on the body section. Two sides of the diaphragm section are connected with two lengthwise sidewalls of the body section as seen in cross section to bridge the diaphragm section between the sidewalls. The diaphragm section and the length of the rectangular cross section contain a predetermined angle. Two protruding rails are disposed on outer face of one of the lengthwise sidewalls of the body section in parallel to each other as seen in cross section. The protruding rails extend along a length of the body section. A side seat protrudes from outer face of the other lengthwise sidewall as seen in cross section. The side seat extends along the length of the body section.

### BACKGROUND OF THE INVENTION

The present invention relates generally to a portal frame type platform, and more particularly to a rigid beam of a portal frame type platform.

At an early stage, portal frame type platforms are applied to traditional machining fields such as frame grinders and frame mills. Following the advance of industrial technologies, various portal frame type platforms have been developed and widely applied to modern high-tech fields such as manufacturing processes of printed circuit boards, photoelectronic products, semiconductor products and flat panel displays. For example, a portal frame type platform can be applied to a large-size laser repair equipment or panel defect inspection system in the manufacturing process of flat panel display.

However, the beam structure of the current portal frame type platform is still made of steel material by means of welding or casting. Due to the properties of the material, such beam structure generally has a considerably heavy weight. As a result, the kinetic performance of the beam structure of the conventional portal frame type platform is insufficient. Furthermore, the beam structure of the conventional portal frame type platform is disadvantageous in that the amplitude decays too slowly and the deformation is too large. Therefore, such beam structure can be hardly satisfactorily used in those fields demanding high precision.

### SUMMARY OF THE INVENTION

It is therefore a primary object of the present invention to provide a rigid beam of portal frame type platform, which is lightweight and has higher static rigidity. Therefore, the rigid beam has better kinetic performance and can be more reliably used.

To achieve the above and other objects, the rigid beam of portal frame type platform of the present invention includes a hollow body section with a substantially rectangular cross section. The body section linearly extends by a predetermined length. At least one diaphragm section is disposed on the body section. Two sides of the diaphragm section are connected with two lengthwise sidewalls of the body section as seen in cross section to bridge the diaphragm section between the sidewalls. The diaphragm section and the length of the rectangular cross section contain a predetermined angle. Two protruding rails are disposed on outer face of one of the lengthwise sidewalls of the body section in parallel to each other as seen in cross section. The protruding rails extend along a length of the body section. A side seat protrudes from outer face of the other lengthwise sidewall as seen in cross section. The side seat extends along the length of the body section.

The present invention can be best understood through the following description and accompanying drawings, wherein:

### BRIEF DESCRIPTION OF THE DRAWINGS

FIG. 1 is a perspective view of a preferred embodiment of the present invention;

FIG. 2 is an end view of the preferred embodiment of the present invention;

FIG. 3 is a perspective view of the preferred embodiment of the present invention, showing that the rigid beam is applied to a portal frame type platform; and

FIGS. 4A to 4E show different layouts of the preferred embodiment of the present invention.

### DETAILED DESCRIPTION OF THE PREFERRED EMBODIMENT

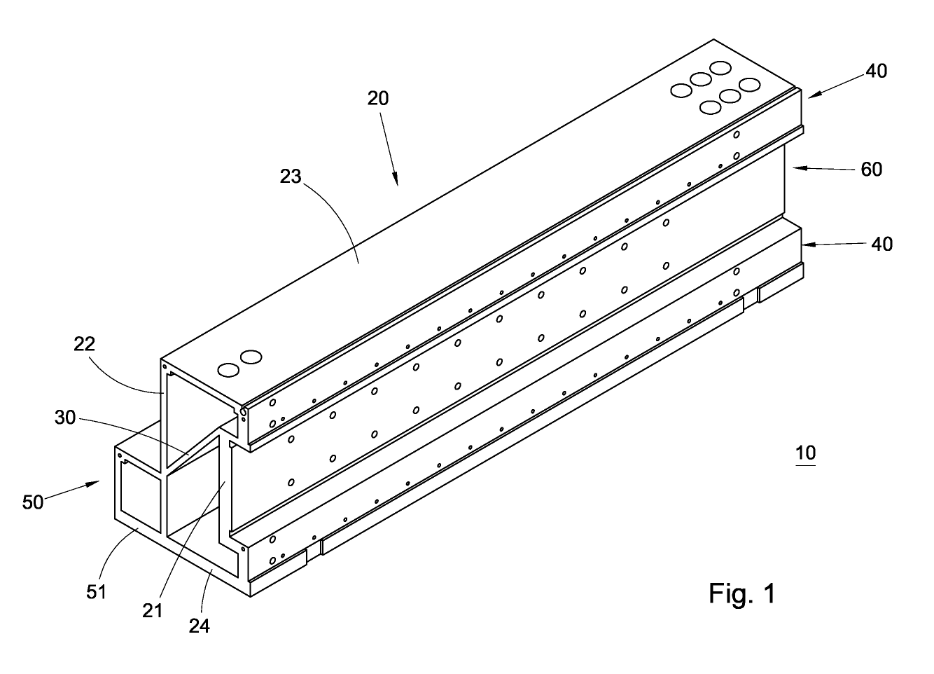

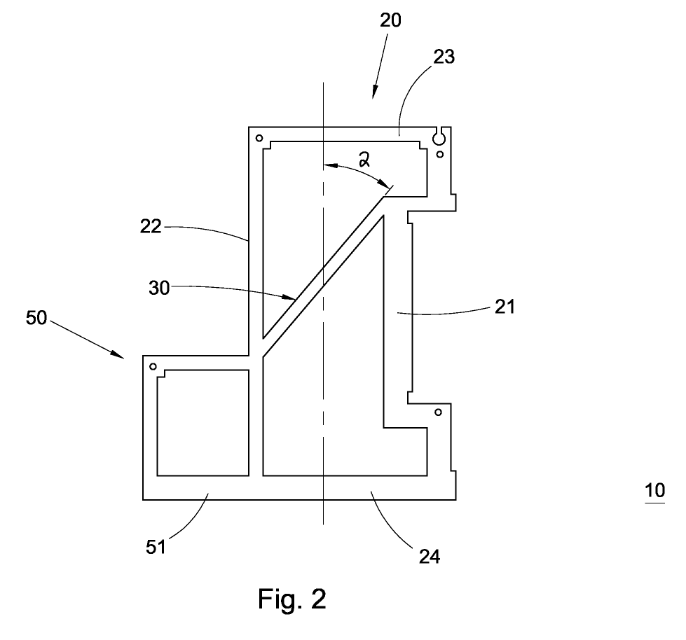

Please refer to FIGS. 1 to 4. According to a preferred embodiment, the rigid beam 10 of the portal frame type platform of the present invention is integrally made by aluminum extrusion. The rigid beam 10 includes a body section 20, a diaphragm section 30, two protruding rails 40 and a side seat 50.

The body section 20 is a hollow section with a substantially rectangular cross section. The body section 20 linearly extends by a certain length as a main part of the beam 10.

The diaphragm section 30 has the form of a plane plate and is disposed in the body section 20. Two sides of the diaphragm section 30 are connected with inner faces of a first lengthwise sidewall 21 and a second lengthwise sidewall 22 of the body section 20 as seen in cross section to bridge the diaphragm section 30 between the sidewalls. The diaphragm section 30 extends along a length of the body section 20. A face of the diaphragm section 30 and the length of the rectangular cross section of the body section 20 contain an angle α preferably of about 40 degrees.

The protruding rails 40 are disposed on an outer face of the first lengthwise sidewall 21 of the body section 20 in parallel to each other as seen in cross section. The protruding rails 40 extend along a length of the body section 30 and are spaced from each other. Accordingly, the protruding rails 40 and the outer face of the first lengthwise sidewall 21 of the body section 20 define a recessed receiving space 60.

The side seat 50 is a hollow section with a quadrangular cross section. One side of the side seat 50 is adjoined with an outer face of the second lengthwise sidewall 22 of the body section 20. The side seat 50 has a bottom wall 51. The body section 20 also has a bottom wall 24. A bottom face of the bottom wall 51 of the side seat 50 is flush with a bottom face of the bottom wall 24 of the body section 20.

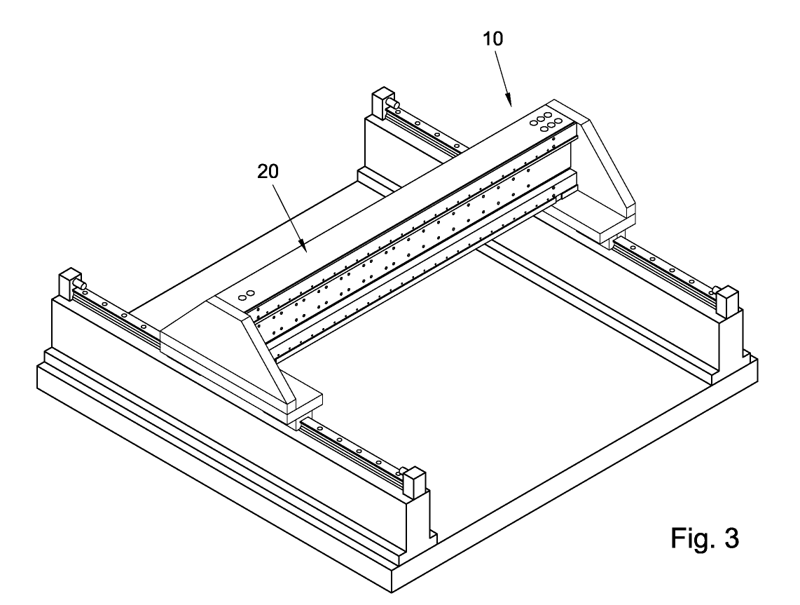

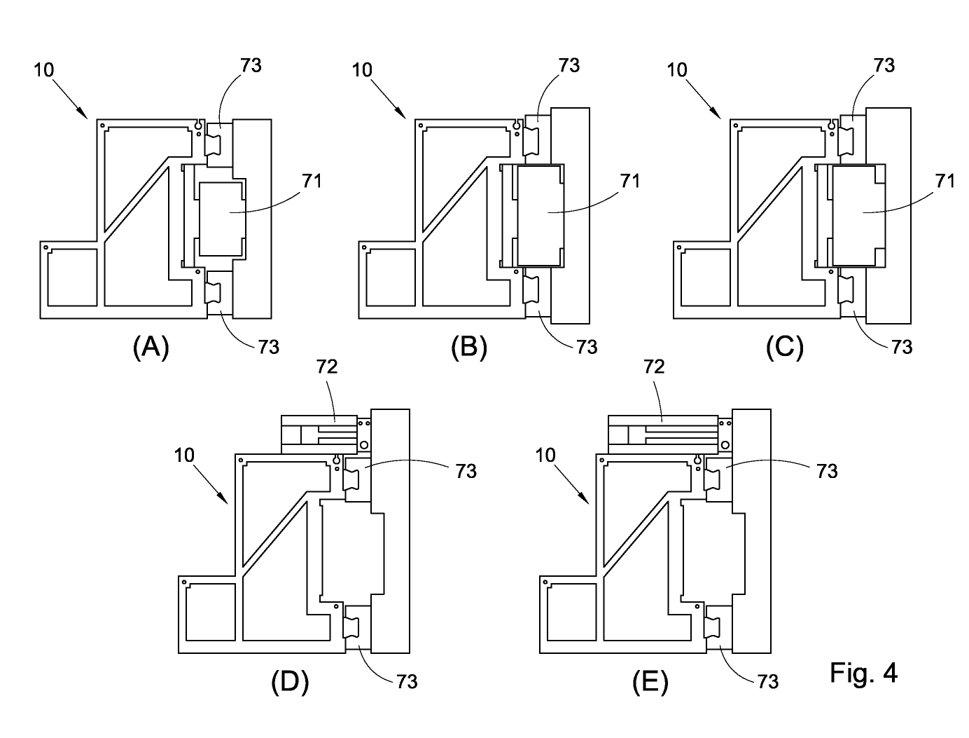

According to the above arrangement, the beam 10 can serve as a beam component of a portal frame type platform as shown in FIG. 3. Different types of guide rails and motor stators can be mounted on the protruding rails 40 and received in the receiving space 60. FIGS. 4A to 4E show some embodiments of the application of the beam 10. A stator 71 of an iron core type linear motor can be received in the receiving space 60. Alternatively, a stator 72 of an iron-coreless linear motor can be mounted on a top face 23 of the body section 20. Linear slide rails 73 can be fixed on the protruding rails 40. In addition, a square cable chain can be fixed and supported on a top face 51 of the side seat 50 to protect the cables that quickly move. Accordingly, the beam 10 can be widely applied to various fields.

It should be noted that:

First, the rigid beam 10 of the portal frame type platform of the present invention is integrally made by aluminum extrusion. Therefore, the weight of the rigid beam 10 is lighter than that of the conventional steel-made beam. Accordingly, the rigid beam 10 has better kinetic performance.

Second, the rigidity of the hollow body section 20 of the rigid beam 10 may be insufficient by itself. However, the diaphragm section 30 serves to reinforce the body section 20 to overcome the problem of rigidity. By means of the diaphragm section 30, the mechanical strength of the rigid beam 10 of the portal frame type platform is increased as a whole. Therefore, the static rigidity of the rigid beam 10 is enhanced to avoid over-deformation.

Third, in the rigid beam structure 10, the angle contained between the diaphragm section 30 and the length of the rectangular cross section of the body section 20 is preferably, but not limited to, about 40 degrees. Substantially, the angle ranges from 20 degrees to 90 degrees. In the case that the angle is 40 degrees as in the above embodiment, not only the diaphragm section 30 can uniformly increase the strength of the body section 20 in cross section, but also the rigid beam 10 can be more easily formed in the aluminum extrusion process. Therefore, the ratio of good products can be increased and the amount of waste material can be minimized. This meets the economic requirement of lower manufacturing cost. Moreover, both the static rigidity and dynamic rigidity of the beam 10 can be enhanced so that the beam 10 can be more reliably used.

Fourth, the rigid beam 10 of the portal frame type platform can be conveniently assembled with the equipments for manufacturing printed circuit boards, photoelectronic products, semiconductor products and flat panel displays in accordance with the requirements in the manufacturing and processing processes. Also, the rigid beam 10 of the portal frame type platform of the present invention is adaptable to different specifications of linear motors. In addition, the rigid beam 10 is lightweight and has high rigidity so that the rigid beam 10 has better kinetic performance than the conventional beam structure.

The above embodiment is only used to illustrate the present invention, not intended to limit the scope thereof. Many modifications of the above embodiment can be made without departing from the spirit of the present invention.

What is claimed is:

1. A rigid beam of portal frame type platform, comprising:
a hollow body section with a substantially rectangular cross section, the body section linearly extending by a predetermined length;
at least one diaphragm section in the form of a plate, the diaphragm section being disposed in the body section, two sides of the diaphragm section being connected with a first lengthwise sidewall and a second lengthwise sidewall of the body section as seen in cross section to bridge the diaphragm section between the sidewalls, the diaphragm section and a length of the rectangular cross section of the body section containing a predetermined angle; and
two protruding rails disposed on an outer face of the first lengthwise sidewall of the body section in parallel to each other as seen in cross section, the protruding rails extending along a length of the body section.

2. The rigid beam of portal frame type platform as claimed in claim 1, wherein the angle contained between the diaphragm section and the length of the rectangular cross section of the body section ranges from 20 degrees to 90 degrees.

3. The rigid beam of portal frame type platform as claimed in claim 1, wherein there is a multiplicity of diaphragm sections in parallel to each other.

4. The rigid beam of portal frame type platform as claimed in claim 3, wherein the angle contained between the diaphragm section and the length of the rectangular cross section of the body section ranges from 20 degrees to 90 degrees.

5. The rigid beam of portal frame type platform as claimed in claim 1, further comprising a side seat disposed on an outer face of the second lengthwise sidewall of the body section and protruding therefrom, the side seat extending along the length of the body section.

6. The rigid beam of portal frame type platform as claimed in claim 5, wherein the side seat is hollow, an outer face of the side seat being flush with an outer face of the body section as seen in cross section.
